(19) United States
(12) Patent Application Publication
(10) Pub. No.: US 2012/0044592 A1
(43) Pub. Date: Feb. 23, 2012

(54) FILTER CONVERSION DEVICE

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/910,814

(22) Filed: Oct. 24, 2010

(30) Foreign Application Priority Data
Aug. 19, 2010 (TW) 99127667

(51) Int. Cl. G02B 5/22

(52) U.S. Cl. 359/889

(57) ABSTRACT

A filter conversion device includes a first filter, a second filter, a motor, and a comparator. The motor moves the first and second filters according to a control signal from a processor of the camera. Two input terminals of the comparator are respectively connected to two input terminals of the motor. An output terminal of the comparator is connected to the processor. The comparator detects the control signal transmitted to the motor and feeds back the detection result to the processor, for determining whether the control signal is correct.

### CROSS-REFERENCE TO RELATED APPLICATION

Relevant subject matter is disclosed in the co-pending U.S. patent application (Attorney Docket No. US34600) having the same title, which is assigned to the same assignee as named herein.

### BACKGROUND

1. Technical Field

The present disclosure relates to a filter conversion device.

2. Description of Related Art

Camera filters are transparent or translucent optical elements that alter the properties of light entering the camera lens for improving the image being captured. Filters can affect contrast, sharpness, highlight flare, color, and light intensity, either individually, or in various combinations. For cameras, which work in the light and in the dark, a conversion device is needed. The conversion device selects a filter in the light and a different filter for dark. However, the camera cannot ensure whether the control signal, which the camera has received to select the corresponding filter is correct.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a filter conversion device.

FIG. 2 is a circuit diagram of the filter conversion device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

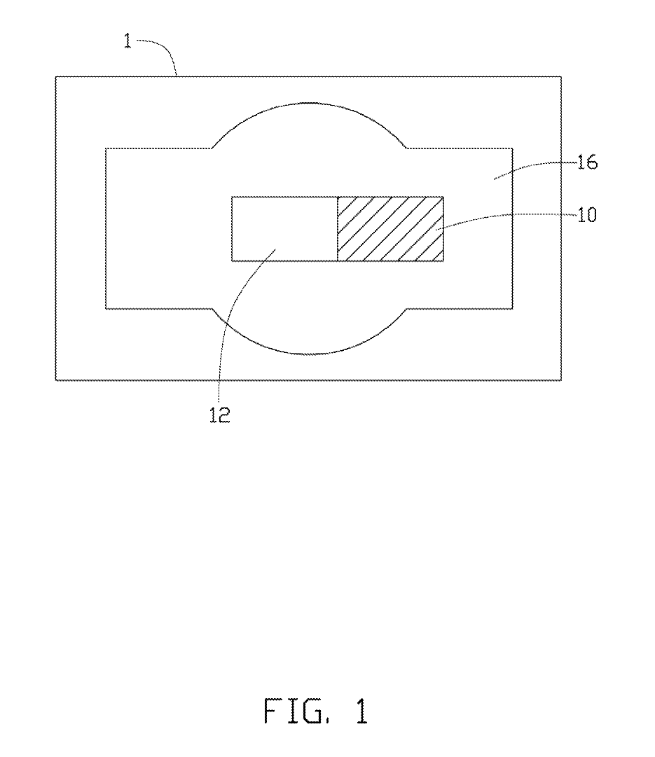

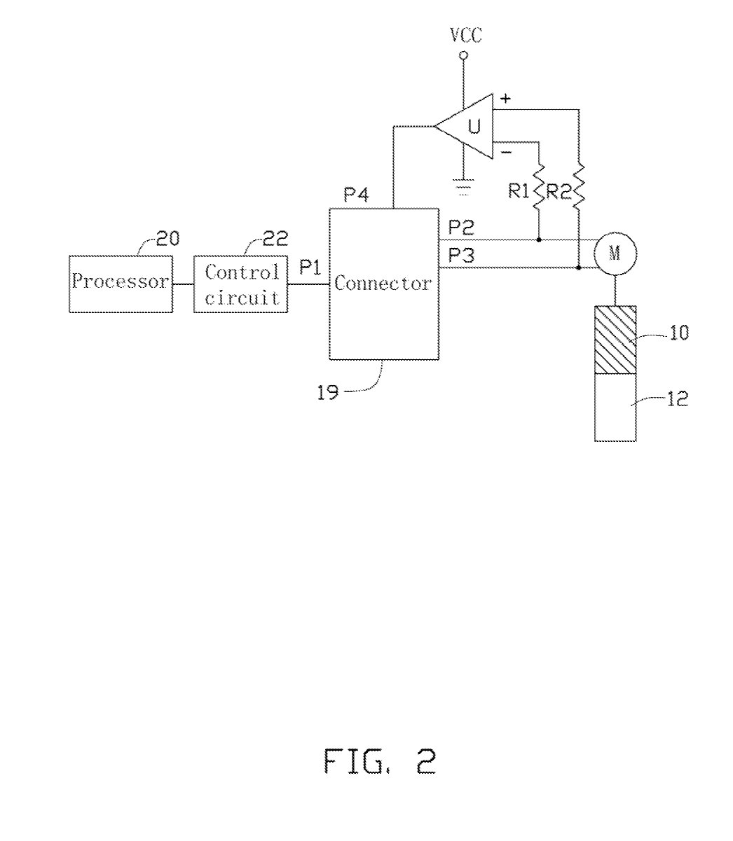

Referring to FIGS. 1 and 2, an exemplary embodiment of a filter conversion device includes a first filter 10, a second filter 12, a motor M, a body 16, a comparator U, and two resistors R1 and R2. The filter conversion device is set between a lens and an image sensor of a camera 1, to select the first filter 10 or the second filter 12 in the light or dark.

The motor M and the comparator U are connected to a processor 20 and a control circuit 22 of the camera with a connector 19. The motor M rotates backward or forward according to a control signal from the processor 20 and the control circuit 22, to adjust the positions of the first filter 10 and the second filter 12. The comparator U detects the control signal transmitted to the motor M and feeds back the detection result to the processor 20, to determine whether the control signal is correct.

The connector 19 includes first to fourth terminals P1-P4. The first terminal P1 is connected to the processor 20 with the control circuit 22 of the camera. The second terminal P2 and the third terminal P3 are respectively connected to two terminals of the motor M. The second terminal P2 is also connected to an inverting terminal of the comparator U with the resistor R1, and the third terminal P3 is also connected to a non-inverting terminal of the comparator U with the resistor R2. The fourth terminal P4 of the comparator U is connected to an output terminal of the comparator U. A power terminal of the comparator U is connected to a power source Vcc, and a ground terminal of the comparator U is grounded.

If the voltage of the second terminal P2 of the connector 19 is greater than the voltage of the third terminal P3 of the connector 19, the motor M rotates forward. As a result, the first filter 10 and the second filter 12 move left (FIG. 1), and the first filter 10 is selected. When the voltage of the second terminal P2 of the connector 19 is less than the voltage of the third terminal P3 of the connector 19, the motor M rotates backward. As a result, the first filter 10 and the second filter 12 move right, and the second filter 12 is selected.

If the processor 20 outputs a first control signal to control the motor M to rotate forward to move the first filter 10 and the second filter 12 left, the control circuit 22 outputs a first voltage signal Va and a second voltage signal Vb to the two terminals of the motor M according to the first control signal. The comparator U compares the first voltage signal Va with the second voltage signal Vb. If the first voltage signal Va is greater than the second voltage signal Vb, the comparator U feeds back a high level signal to the processor 20. The processor 20 determines that the control signal, which the motor M receives to select the corresponding filter is correct. If the first voltage signal Va is less than the second voltage signal Vb, the comparator U feeds back a low level signal to the processor 20. The processor 20 determines that the control signal, which the motor M receives to select the corresponding filter is incorrect. At this time, the camera warns the operators to check the camera.

If the processor 20 outputs a second control signal to control the motor M to rotate backward to move the first filter 10 and the second filter 12 right. The control circuit 22 outputs a third voltage signal Va′ and a fourth voltage signal Vb′ to the two terminals of the motor M according to the second control signal. The comparator U compares the third voltage signal Va′ with the fourth voltage signal Vb′. If the third voltage signal Va′ is less than the fourth voltage signal Vb′, the comparator U feeds back a low level signal to the processor 20. The processor 20 determines that the control signal, which the motor M receives to select the corresponding filter is correct. If the third voltage signal Va′ is greater than the fourth voltage signal Vb′, the comparator U feeds back a high level signal to the processor 20. The processor 20 determines that the control signal, which the motor M receives to select the corresponding filter is incorrect. At this time, the camera warns operators to check the camera.

The foregoing description of the embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A filter conversion device for a camera, the filter conversion device comprising:
a first filter;
a second filter;
a motor to move the first and second filters according to a control signal from a processor of the camera; and
a comparator, wherein two input terminals of the comparator are respectively connected to two input terminals of the motor, an output terminal of the comparator is connected to the processor, the comparator detects the control signal transmitted to the motor and feeds back the detection result to the processor, for determining whether the control signal is correct.

2. The filter conversion device of claim 1, wherein the two input terminals of the comparator are an inverting terminal connected to a first input terminal of the motor with a first resistor, and a non-inverting terminal connected to a second input terminal of the motor with a second resistor.

3. The filter conversion device of claim 1, wherein the motor and the comparator are connected to the processor with a connector.

4. The filter conversion device of claim 1, wherein the motor and the comparator are connected to the processor with a control circuit.
